(19) United States
(12) Patent Application Publication
(10) Pub. No.: US 2014/0112395 A1
(43) Pub. Date: Apr. 24, 2014

(54) METHOD AND APPARATUS FOR DECODER BUFFERING IN HYBRID CODED VIDEO SYSTEM

(71) Applicant: Electronics and Telecommunications Research Institute, Daejeon-si (KR)

(72) Inventors: Gwang Soon LEE, Daejeon (KR); Kug Jin YUN, Daejeon (KR); Jin Young LEE, Daejeon (KR); Hyun Jeong YIM, Seoul (KR); Eung Don LEE, Daejeon (KR); Won Sik CHEONG, Daejeon (KR); Nam Ho HUR, Daejeon (KR)

(73) Assignee: Electronics and Telecommunications Research Institute, Daejeon-si (KR)

(21) Appl. No.: 14/059,913

(22) Filed: Oct. 22, 2013

(30) Foreign Application Priority Data
Oct. 22, 2012 (KR) 10-2012-0117339
Oct. 29, 2012 (KR) 10-2012-0120383
Oct. 22, 2013 (KR) 10-2013-0125809

(51) Int. Cl. H04N 19/89

(52) U.S. Cl. CPC H04N 19/00933
USPC 375/240.28; 375/240.26

(57) ABSTRACT

Disclosed is a transport device in a video system which uses a hybrid video codec. The transport device includes a first video encoder which encodes a first video using a first video codec, a second video encoder which encodes a second video using a second video codec, and a delay buffer for synchronizing a delay time for the first video and the second video, based on a buffer size of if a first transport stream system target decoder (T-STD) stipulated in the first video encoder and a buffer size of a second T-STD stipulated in the second video encoder.

### CROSS-REFERENCE TO RELATED APPLICATIONS

This application claims the benefit of priority of Korean Patent Application No. 10-2012-0117339 filed on Oct. 22, 2012, Korean Patent Application No. 10-2012-0120383 filed on Oct. 29, 2012, and Korean Patent Application No. 10-2013-0125809 filed on Oct. 22, 2013, all of which are incorporated by reference in its entirety herein.

### BACKGROUND OF THE INVENTION

1. Field of the Invention

The present invention relates to a hybrid codec video system, and more particularly, to a buffer model of a system target decoder (STD).

2. Related Art

Moving pictures exports group-2 (MPEG-2) video compression standard (ISO/IEC 13818-2) has been applied to a digital image transmission and reception system, and has been widely applied as a standard codec in an American digital broadcasting standard (an advanced television systems committee (ATSC)). For example, a video encoder, to which MPEG-2 video compression standard has been applied, and dedicated chipsets thereof have been introduced, and various forms of MPEG-2 decoder chips have been mounted on the ATSC DTV set and set-top box, etc.

Furthermore, the MPEG-4 advanced video coding (AVC) compression standard has a compression efficiency superior to the MPEG-2 video compression standard, and is widely used.

Furthermore, in a system for providing a 3D service, such as a 3D TV broadcasting system, a left image and a right image may be respectively encoded using different video codecs. For example, the left image may be encoded using the MPEG-2 video compression standard, and the right image may be encoded using the MPEG-4 AVC compression standard. In such a case, at the receiving side, the left image and the right image encoded using different video codecs are received, and the received left image and right image may be respectively decoded using the decoders so as to be simultaneously replayed on the screen. At this time, the sizes of the buffers, which are needed in the decoder for decoding the left image and the decoder for decoding the right image, are different, and thus if the left image and the right image are simultaneously decoded and are replayed on the screen, the decoder buffering and synchronization problem may occur.

Hence, there is a need for a decoder buffering method which is appropriate to the image system that uses a hybrid video codec.

### SUMMARY OF THE INVENTION

An object of the present invention is to provide a system target decoder buffering method and device which fit a video system which uses a hybrid video codec.

In accordance with an aspect of the present invention, a transport device in a video system which uses a hybrid video codec includes a first video encoder which encodes a first video using a first video codec, a second video encoder which encodes a second video using a second video codec, and a delay buffer for synchronizing a delay time for the first video and the second video, based on a buffer size of if a first transport stream system target decoder (T-STD) stipulated in the first video encoder and a buffer size of a second T-STD stipulated in the second video encoder.

In accordance with another aspect of the present invention, a receiving device in a video system which uses a hybrid video codec includes a first video decoder which decodes a received transport stream using a first video codec, a second video decoder which decodes the transport stream using a second video codec, and a delay buffer which is connected to the first video decoder and operates.

A size of the delay buffer may be determined based on a difference between a buffer size of a first transport stream system target decoder (T-STD) stipulated in a first video encoder and a buffer size of a second T-STD stipulated in the second video encoder, and the first T-STD may be the first video decoder and the second T-STD may be the second video decoder.

In accordance with yet another aspect of the present invention, a decoder buffering method in a video system which uses a hybrid video codec includes receiving a transport stream which is generated by multiplexing a first video encoded by a first video encoder and a second video encoded by a second video, adjusting a buffer for a first transport stream system target decoder stipulated in the first video encoder and a second T-STD stipulated in the second video encoder, and decoding the transport stream by the first T-STD and the second T-STD based on the adjusted buffer.

According to one or more embodiments of the present invention, as in the 3DTV broadcasting system of a dual stream scheme, even if a video is encoded using a hybrid encoder having T-STD buffers of different standards, the maximum image quality may be maintained by stipulating the decoder buffer of the maximum allowed range.

Furthermore, the buffer capacity limit within an already introduced decoder chipset may be overcome by stipulating the decoder buffer of the maximum allowed range. The difference of the delay time, which is generated when the bit streams, which have been encoded through a hybrid codec, are transmitted through different hybrid networks, respectively, may be overcome.

### BRIEF DESCRIPTION OF THE DRAWINGS

FIG. 1 is a diagram illustrating an example of a transport stream system target decoder (T-STD or TS-STD) in an MPEG-2 system.

FIG. 2 is a diagram illustrating an example of a video system to which a hybrid video codec has been applied.

FIG. 3 is a diagram illustrating an example of a video system to which a hybrid video codec has been applied, according to an embodiment of the present invention.

FIG. 4 is a diagram illustrating another example of a video system to which a hybrid video codec has been applied, according to an embodiment of the present invention.

FIG. 5 is a diagram illustrating a decoder buffering method in a video system to which a hybrid video codec has been applied, according to an embodiment of the present invention.

FIG. 6 is a flowchart illustrating a decoder buffering method in a video system to which a hybrid video codec has been applied, according to an embodiment of the present invention.

### DESCRIPTION OF EXEMPLARY EMBODIMENTS

Some exemplary embodiments of the present invention are described in detail with reference to the accompanying drawings. Furthermore, in describing the embodiments of this specification, a detailed description of the known functions and constitutions will be omitted if it is deemed to make the gist of the present invention unnecessarily vague.

In this specification, when it is said that one element is connected or coupled with the other element, it may mean that the one element may be directly connected or coupled with the other element or a third element may be connected or coupled between the two elements. Furthermore, in this specification, when it is said that a specific element is included, it may mean that elements other than the specific element are not excluded and that additional elements may be included in the embodiments of the present invention or the scope of the technical spirit of the present invention.

Terms, such as the first and the second, may be used to describe various elements, but the elements are not restricted by the terms. The terms are used to only distinguish one element from the other element. For example, a first element may be named a second element without departing from the scope of the present invention. Likewise, a second element may be named a first element.

Furthermore, element units described in the embodiments of the present invention are independently shown to indicate difference and characteristic functions, and it does not mean that each of the element units is formed of a piece of separate hardware or a piece of software. That is, the element units are arranged and included, for convenience of description, and at least two of the element units may form one element unit or one element may be divided into a plurality of element units and the plurality of divided element units may perform functions. An embodiment into which the elements are integrated or embodiments from which some elements are separated are also included in the scope of the present invention, unless they depart from the essence of the present invention.

Furthermore, in the present invention, some elements are not essential elements for performing essential functions, but may be optional elements for improving only performance. The present invention may be implemented using only essential elements for implementing the essence of the present invention other than elements used to improve only performance, and a structure including only essential elements other than optional elements used to improve only performance is included in the scope of the present invention.

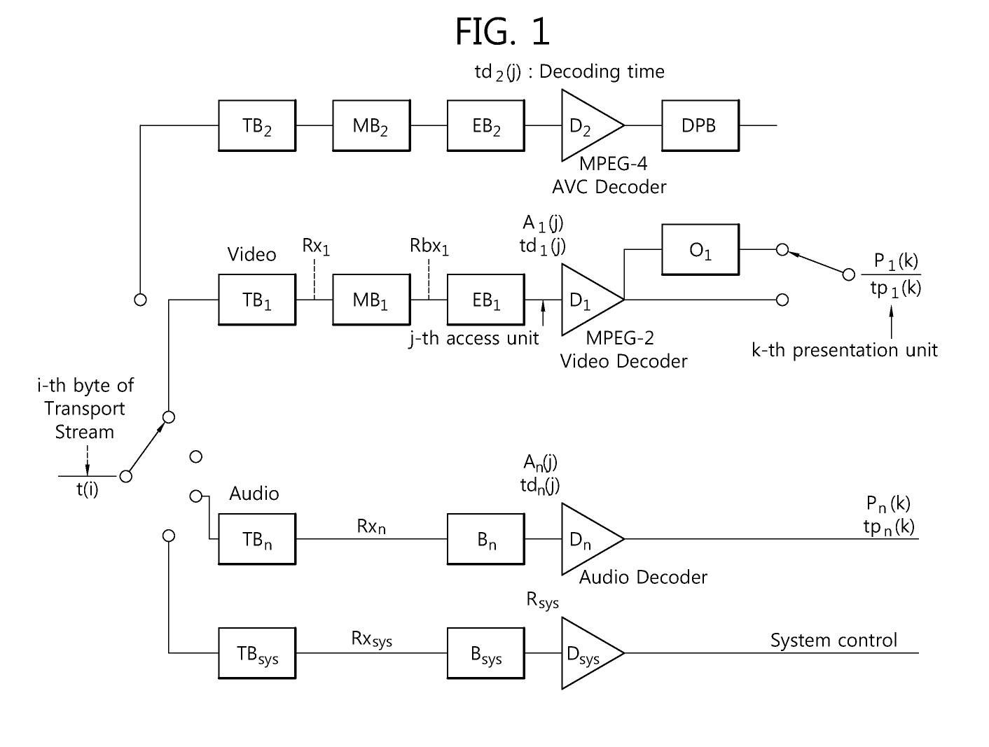

FIG. 1 is a diagram illustrating an example of a transport stream system target decoder (T-STD or TS-STD) in an MPEG-2 system.

The MPEG-2 system stipulates a virtual reference decoder model which is called as a system target decoder for buffer management at the time of synchronous replay and decoding. The STD includes the buffer for the screen replay and decoding, and defines the size, the input and output scheme, and the bitrate of the buffers. For example, as illustrated in FIG. 1, when a bitstream, which has been encoded as the MPEG-2 video and the MPEG-4 AVC, is multiplexed as an MPEG-2 transport stream (TS) and is transmitted, the receiver, which has received such a transport stream, may perform a de-multiplexing, decoding, and screen replay. At this time, the T-STD of the receiver side defines the maximum size of the buffer, which is needed for each step for the de-multiplexing, decoding, and screen replay, and time when data is outputted at each buffer (ISO/IEC 13818-1 Information technology—Generic coding of moving pictures and associated audio information: systems; refer to the standard of the year 2007). The buffer, which is needed for each step, may be a transport buffer (TB), a multiplexing buffer (MB), and an elementary stream buffer (EB), as illustrated in FIG. 1.

The T-STD model may be used to limit a buffer which is virtually needed at each encoder output unit and to control the bitrate of each buffer. For example, the T-STD model may control the bitrate which is generated for certain time. The MPEG-4 AVC of the maximum STD buffer, which is allowed through the standard, is about 10 times greater than that of the MPEG-2 video. It is because the MPEG-4 AVC, as the latest video codec, requires a lot of buffers to perform a complicated algorithm. Furthermore, as a complicated algorithm is applied as in a hierarchical group of picture (GOP) structure, the required buffer gets bigger, and as such, the delay time at the time of encoding and decoding may increase.

For example, the MPEG-2 transport stream packet, which is encoded through the MPEG-2 video encoder and is multiplexed, may be inputted to the T-STD and be decoded with a delay of the maximum 1 second, but the MPEG-2 transport stream packet, which is encoded through the MEPG-4 AVC encoder and is multiplexed, may be inputted to the T-STD and be decoded with a delay of the maximum 10 seconds.

Likewise, when the transport stream, which is encoded through the encoders that use different codecs (e.g. an MPEG-2 video encoder and an MPEG-4 AVC encoder) and is multiplexed, is received, the receiving side respectively decodes and synchronizes the transport stream through the T-STD (e.g., the MPEG-2 video decoder and the MPEG-4 AVC decoder) which uses different codecs at the same time point so as to replay the video, and at this time, a problem may be generated due to a difference in delay time between different T-STDs.

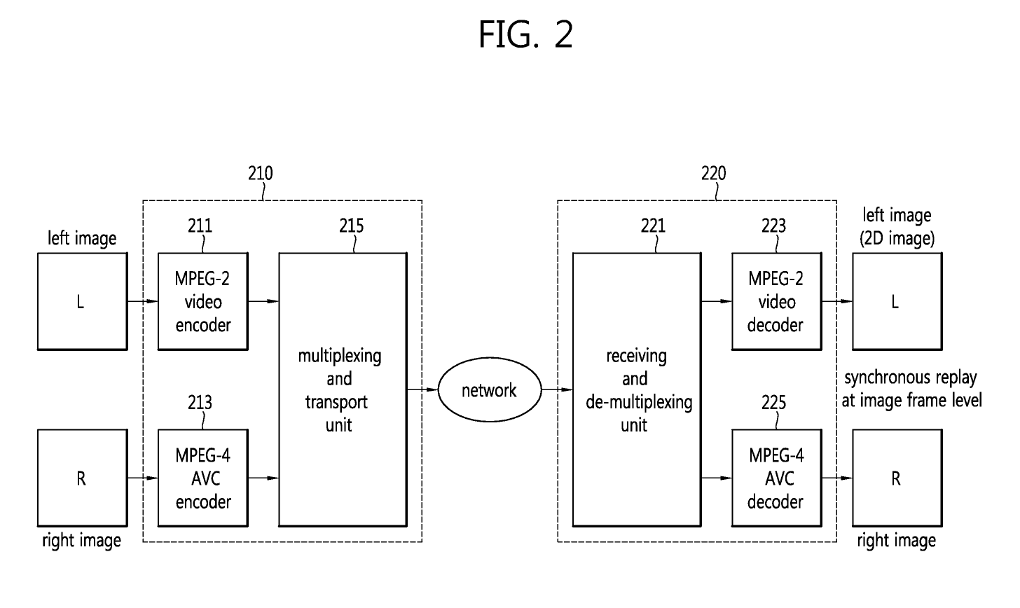

FIG. 2 is a diagram illustrating an example of a video system to which a hybrid video codec has been applied. The video system of FIG. 2 may be a hybrid-coded service-compatible or service-compatible hybrid-coded (SCHC) 3DTV broadcasting system based on a dual stream scheme.

Referring to FIG. 2, the video system may include a transport device 210 which provides 3D images and a receiving device 220 which receives and replays 3D images. At this time, the 3D images generated by the transport device 210 may be transmitted to the receiving device 200 through the transport network. The transport network may include different hybrid networks, for example, may be a network formed of a broadcasting network and a communication network.

The transport device 210 includes an MPEG-2 video encode 211, an MPEG-4 AVC encoder 213, a multiplexing and transport unit 215.

The MPEG-2 video encoder 211 encodes the left image L using the MPEG-2 video compression standard (MPEG-2 video codec), and encodes the right image R using the MPEG-4 AVC compression standard (MPEG-4 AVC codec). The multiplexing and transport unit 215 multiplexes the left image L and the right image R, which have been encoded through respective encoders, as the MPEG-2 transport stream so as to be transmitted.

The receiving device 220 includes a receiving and de-multiplexing unit 221, an MPEG-2 video decoder 223, and an MPEG-4 AVC decoder 225. For example, the receiving device 220 may be a 3DTV receiver or a 3DTV set-top box.

The receiving and de-multiplexing unit 221 receives and de-multiplexes the MPEG-2 transport stream which is transmitted from the transport device 210. The de-multiplexed transport stream may be inputted to the MPEG-2 video decoder 223 and the MPEG-4 AVC decoder 225 so as to be decoded.

The MPEG-2 video decoder 223 may decode the stream de-multiplexed based on the MPEG-2 video codec so as to generate the left image L, and the MPEG-4 AVC decoder 225 may decode the stream de-multiplexed based on the MPEG-2 video codec so as to generate the right image L. The left image L and the right image R may be simultaneously replayed at the image frame level through the receiving device 220.

At this time, when the streams, which are encoded to have the different allowed T-STD buffer capacities (to have different delay time) as in the MPEG-2 video and the MPEG-4 AVC, are decoded and are simultaneously replayed, the overflow or underflow of the decoder buffer may occur due to the buffer capacity difference of each decoder in the receiving device 220.

As described above, in the case of a video system which uses a hybrid video codec, the images are encoded using a hybrid encoder having the T-STD buffer size of different standards, and the receiving side, which receives the images, also decodes the images using a hybrid decoder having the T-STD of different standards. Hence, an overflow or underflow phenomenon of the decoder buffer may occur, and there may be a problem in the replay and synchronization of the images.

In order to resolve the above problem, the present invention provides a buffer model of a system target decoder (STD) which fits the video system to which a hybrid video codec has been applied.

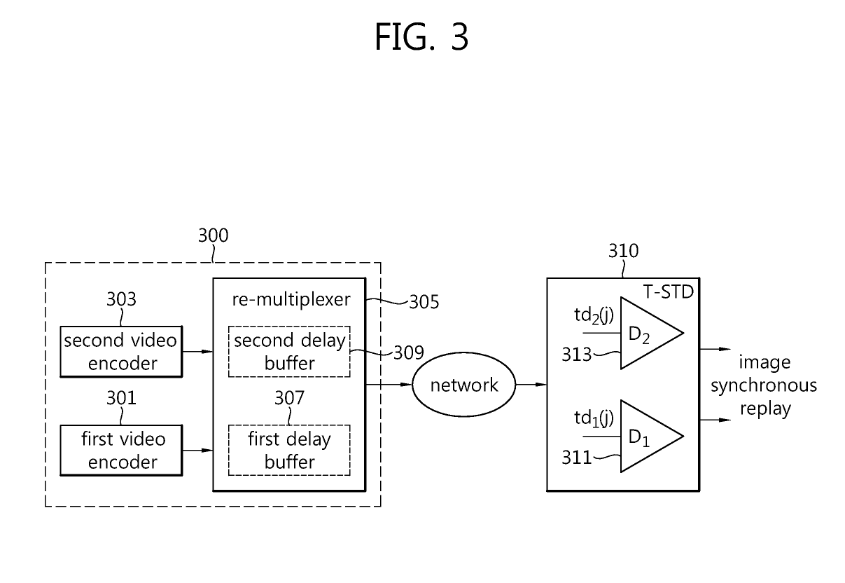

FIG. 3 is a diagram illustrating an example of a video system to which a hybrid video codec has been applied, according to an embodiment of the present invention.

Referring to FIG. 3, the video system, to which the hybrid video codec has been applied, may include a transport device 300 which transmits a transport stream which is generated through a hybrid video codec, and a receiving device 310 which receives the transport stream through the transport network and replays the received transport stream. At this time, the transport network may be composed of different hybrid networks such as a broadcasting network and a communication network.

The transport device 300 includes a first video encoder 301, a second video encoder 303, and delay buffers 307 and 309.

The first video encoder 301 may encode a first video using the first video codec and the second video encoder may encode the second video using the second video codec.

At this time, the first video codec may be an MPEG-2 video codec, and the second video codec may be an MPEG-4 AVC codec. Furthermore, the first video codec may be an MPEG-4 AVC codec, and the second video codec may be a high efficiency video coding (HEVC) codec. In other words, the first video encoder 301 may correspond to an encoder whose decoder buffer is relatively small as in the MPEG-2 video, and the second video encoder 303 may corresponds to an encoder whose decoder buffer is relatively large as in the MEPG-4 AVC.

The delay buffers 307 and 309 synchronize the first video and the second video based on the buffer size of the first transport stream system target decoder (STD) 311 stipulated in the first video encoder 310 and the buffer size of the second T-STD 313 stipulated in the second video encoder 303.

For example, the transport device 300 may add the first delay buffer 307 at the first video encoder 301 side or add the second delay buffer 309 at the second video encoder 303 side in order to correct the difference between the buffer size of the first T-STD 311 stipulated in the first video encoder 301 and the buffer size of the second T-STD 313 stipulated in the second video encoder 303.

The delay buffers 307 and 309 may be mounted on the encoders 301 and 303, or may be implemented through separate equipment. For example, when the video system, to which a hybrid video codec has been applied according to an embodiment of the present invention, is a service-compatible hybrid-coded (SCHC) 3DTV broadcasting system, the first video encoder 301 and the second video encoder 303 may use the conventional encoder equipment which is implemented based on each video codec, and may synchronize and re-multiplex first and second videos which are encoded by the two encoders 301 and 303 through the 3DTV re-multiplexer 305. At this time, the 3DTV re-multiplexer 305 may synchronize the first and second videos by delaying the first or second videos which have been encoded through the delay buffers 307 and 309.

For example, the 3DTV re-multiplexer 305 may include the first delay buffer 307. The first delay buffer 307 may receive the first video, for example, an MPEG-2 video stream, encoded by the first video encoder 301, and may delay the encoded first video by the delay time which is determined based on the difference between the buffer size of the first T-STD 311 and the buffer size of the second T-STD 313.

As another example, the 3DTV re-multiplexer 305 may include the second delay buffer 309. The second delay buffer 309 may receive the second video, for example, an MPEG-4 AVC stream, encoded by the second video encoder 303, and may delay the encoded second video by the delay time which is determined based on the difference between the buffer size of the first T-STD 311 and the buffer size of the second T-STD 313.

The 3DTV re-multiplexer 305 may generate the transport stream by re-multiplexing the first video and the second video whose delay time has been synchronized through the first delay buffer 307 or the second delay buffer 309, and may transmit the transport stream to the receiving device 310 through a transport network.

Likewise, by adding the delay buffer to the transport device 300, the receiving device 310 may use the chipset, which is implemented as the T-STD (see FIG. 1) of the conventional MPEG-2 system, as itself. However, if the first video, which is encoded by the first video encoder 301, is delayed through the first delay buffer 307, a screen delay phenomenon may occur in the receiving device 310 which receives the bit stream, which is outputted from the first video encoder 301, when decoding and replaying the bit stream.

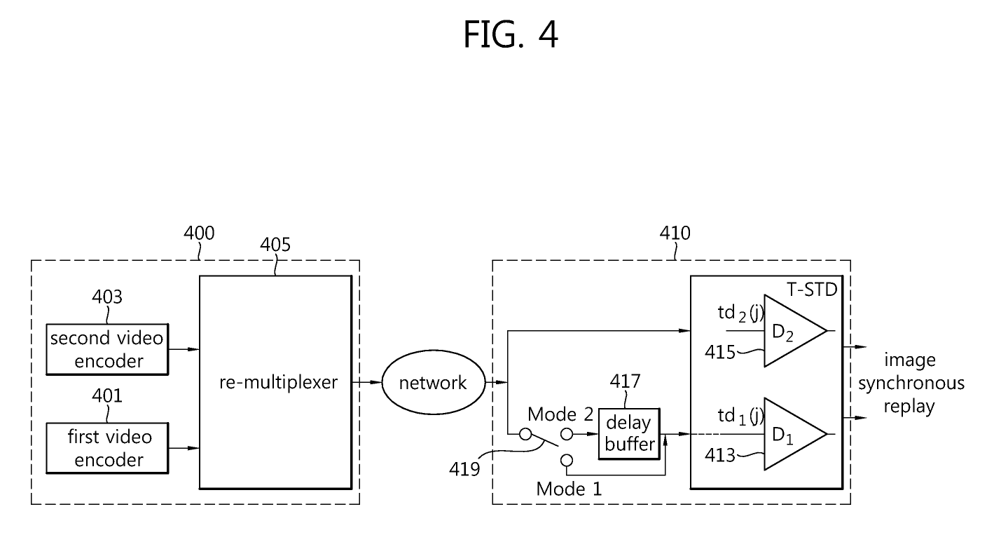

FIG. 4 is a diagram illustrating another example of a video system to which a hybrid video codec has been applied, according to an embodiment of the present invention.

Referring to FIG. 4, a video system, to which a hybrid video codec has been applied, may include a transport device 400 which transmits a transport stream generated through the hybrid video codec, and a receiving device 410 which receives the transport stream through the transport network and replays the received transport stream. At this time, the transport network may be formed of different hybrid networks. For example, the transport network may be a network formed of a broadcasting network and a communication network.

The transport device 400 may include a first video encoder 401 which encodes the first video using the first video codec and a second video which encodes the second video using the second video codec. Furthermore, the transport device 400 may include the re-multiplexer 405 which generates a transport stream by re-multiplexing the encoded first video and second video, and may transmit the transport stream to the receiving device 410.

At this time, the first video codec may be an MPEG-2 video codec, and the second video codec may be an MPEG-4 AVC codec. Furthermore, the first video codec may be an MPEG-4 AVC codec, and the second video codec may be a high efficiency video coding (HEVC) codec. In other words, the first video encoder 401 may correspond to an encoder whose decoder buffer is relatively small as in the MPEG-2 video, and the second video encoder 403 may correspond to an encoder whose decoder buffer is relatively large as in the MPEG-4 AVC.

The receiving device 410 includes a first video decoder 413, a second video decoder 415, and a delay buffer 417. For example, the receiving device 410 may be a 3DTV receiver or a 3DTV set-top box.

The first video decoder 413 may decode the transport stream, which has been received from the transport device 400, using the first video codec, and the second video decoder 415 may decode the transport stream, which has been received from the transport device 400, using the second video codec. At this time, the first video decoder 413 and the second video decoder 415 may be decoders which have been implemented as a T-STD model in the MPEG-2 system as described with reference to FIG. 1.

At this time, the first video codec may be an MPEG-2 video codec, and the second video codec may be an MPEG-4 AVC codec. Furthermore, the first video codec may be an MPEG-4 AVC codec, and the second video codec may be a high efficiency video coding (HEVC) codec. Furthermore, the first video decoder 413 may receive a first stream (a first video), which is encoded in the first video encoder 401 and is outputted, and decode the received first stream, and the second video decoder 415 may receive a second stream (a second video), which is encoded in the second video encoder 403 and is outputted, and decode the received second stream.

The delay buffer may be connected to the first video decode 413 so as to be operated. For example, the delay buffer may be added to the front of the first video decoder 413, and a transport stream, which is received from the transport device 400, may be delayed for a predetermined delay time and the transport stream may then be transmitted to the first video decoder 413.

Here, the transport stream, which is received from the transport device 400, may include a first stream, which is encoded in the first video encoder 401, and a second stream, which is encoded in the second video encoder 403, as described above. The second stream, which is encoded in the second video encoder 403, may be inputted to the second video decoder 415 regardless of the delay buffer 417, and may be decoded. Furthermore, the first stream, which is encoded in the first video encoder 401, may be delayed after passing through the delay buffer 417 and then be inputted to the first video decoder 413, or may be inputted to the first decoder 413 without passing through the delay buffer 417 and then be decoded.

The receiving device 410 may include a switch 419 in front of the delay buffer 417 to be operated for the transport stream, which is received from the transport device 400, at the first mode or the second mode.

For example, in the case of the first mode, the switch 419 is converted into the first mode, and the transport stream (specifically, the first stream which has been encoded in the first encoder 401) may be inputted to the first decoder 413 without a delay by the delay buffer and be decoded. In the case of the second mode, the switch 419 is converted into the second mode, and the transport stream (specifically, the first stream which has been encoded in the first video encoder 401) may be inputted to the delay buffer 417, be delayed for a predetermined delay time, and be transmitted to the first video decoder 413 so as to be decoded.

When the receiving device 410 decodes only the first stream which is encoded in the first video encoder 401 and is outputted, the receiving device 410 may operate at the first mode. In such a case, the first stream may be promptly inputted to the first video decoder 413 to be decoded without passing through the delay buffer 417, and thus there is no additional time delay. In contrast, when the receiving device 410 receives a video such as a 3DTV, i.e., a stream which is respectively encoded by the first video encoder 401 and the second video encoder and is multiplied, and synchronizes and replays the received stream, the receiving device 410 may operate at the second mode. In this case, the stream is decoded by simultaneously operating the first video decoder 413 and the second video decoder 415, and the stream, which is encoded by the second video encoder 403, may be promptly inputted to the second video decoder 415 so as to be decoded. Furthermore, the stream, which is encoded by the first video encoder 401, may pass through the delay buffer 417, and be inputted to the first video decoder 413 so as to be decoded.

As described above, when a delay buffer is added to the receiving side, the receiving side may regulate the delay time for the transport stream through the delay buffer, and thus even if only the stream, which has been encoded without using a hybrid video codec, is received and decoded, a screen delay phenomenon may not occur.

The size of the delay buffer 417 may be determined based on the difference between the buffer size of the first transport stream system target decoder (T-STD) stipulated in the first video encoder 401, and the buffer size of the second T-STD stipulated in the second video encoder 403. At this time, the first T-STD refers to the first video decoder 413, and the second T-STD refers to the second video decoder 415.

At the actual operation, the delay time by the delay buffer 417 may be determined based on at least one of an encoding condition of the first video encoder 401 and the second video encoder 403, a difference value between a first decoding time stamp (DTS) and a second DTS which are drawn based on the reference time within the received transport stream, and a difference value between the buffer initial delay time of the first T-STD and the buffer initial delay time of the second T-STD.

Here, the reference time value may be a program clock reference (PCR) within the transport stream, and the PCR is a value which is made from the system clock of the encoder. Here, the PCR value may be received in the decoder, and the received PCR value may be set as a reference time value of a program to be currently decoded so as to obtain a DTS. The first DTS may be information indicating a time point when a transport stream, which is inputted to the first video decoder 413, is to be decoded, and the second DTS may be information indicating a time point when a transport stream, which is inputted to the second video decoder 415, is to be decoded.

The buffer initial delay time of the first T-STD may use the video buffering verifier (Vbv)_delay value of the MPEG-2 video, for example, if the first video decoder 413 uses the MPEG-2 video codec. The buffer initial delay time of the second T-STD may use the initial_cpb(coded picture buffer)_removal_delay value of the MPEG-4 AVC, for example, if the second video decoder 415 uses the MPEG-4 AVC codec.

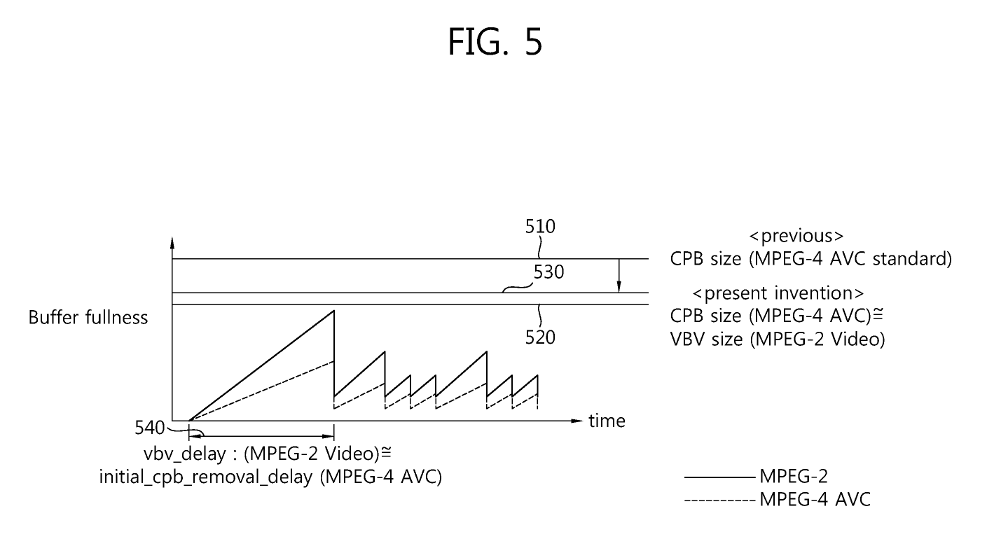

FIG. 5 is a diagram illustrating a decoder buffering method in a video system to which a hybrid video codec has been applied, according to an embodiment of the present invention.

The video system, to which a hybrid video codec has been applied according to an embodiment of the present invention, may include a transport device which transmits a transport stream which has been encoded using a hybrid video codec, and a receiving device which receives the transport stream from the transport device and decodes the received transport stream. For example, the transport device may include a first video encoder which encodes a first video based on the first video codec such as an MPEG-2 video, and a second video encoder which encodes a second video based on the second video codec such as an MPEG-4 AVC. The receiving device may include a first video decoder which decodes a first video which is received based on the first video codec such as an MPEG-2 video, and a second video decoder which decodes a second video which is received based on the second video codec such as an MPEG-4 AVC.

In the video system which uses a hybrid video codec as described above, if the buffer size of the second T-STD, which is allowed in the second video encoder, is greater than the buffer size of the first T-STD which is allowed in the first video encoder, the decoder buffering method according to an embodiment of the present invention may limit the buffer capacity of the second T-STD which may be actually used. Here, the first T-STD refers to the first video decoder, and the second T-STD refers to the second video decoder.

For example, as illustrated in FIG. 5, the buffer size (cpb_size) 510 of the T-STD defined in the MPEG-4 AVC standard is greater than the buffer size (VBV_size) 520 of the T-STD defined in the MPEG-2 video standard. In such a case, in the present invention, the buffer size (cpb_size) 510 of the T-STD defined in the MPEG-4 AVC standard may be adjusted to be the same as or similar to the buffer size (VBV_size) 520 of the T-STD defined in the MPEG-2 video standard.

Furthermore, in the video system which uses the hybrid video codec as described above, if the buffer size of the second T-STD, which is allowed in the second video encoder, is greater than the buffer size of the first T-STD, which is allowed in the first video encoder, the buffer initial delay time of the second T-STD may be adjusted to be the same as or similar to the buffer initial delay time of the first T-STD.

For example, in the MPEG-2 video and the MPEG-4 AVC, the buffer delay at the early part of the decoding may be controlled in access units through Vbv_delay and the initial_cpb_removal_delay, respectively (refer to ISO/IEC 13818-2 and ISO/IEC 14496-10). The initial bitrates of the streams, which are respectively encoded based on the MPEG-2 video and the MPEG-4 AVC, are controlled through the Vbv_delay and the initial_cpb_removal_delay, and in this process, the delay time of the bitstream may be determined. For example, in order to reduce the buffer delay time of the second T-STD of the second video encoder, the buffer initial delay time of the second T-STD of the second video encoder (the initial_cpb_removal_delay value of the MPEG-4 AVC) of the second T-STD of the second video encoder may be set to be the same as or similar to the buffer initial delay time (the Vbv_delay of the MPEG-2 video) of the first T-STD of the first video encoder (540). The information on the initial delay time of the decoder buffer may be transmitted through the SEI message (refer to ISO/IEC 14496-10) as necessary.

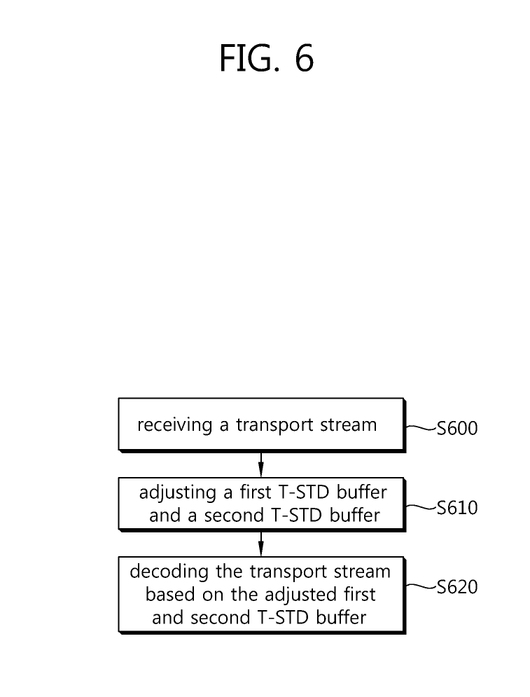

FIG. 6 is a flowchart illustrating a decoder buffering method in a video system to which a hybrid video codec has been applied, according to an embodiment of the present invention. For example, the method of FIG. 6 may be performed in the receiving device, or may be performed in a separate control device. Furthermore, the decoder buffer may be regulated in the transmission device.

Referring to FIG. 6, the receiving device receives a transport stream which is generated by multiplexing a first video, which is encoded by the first video encoder, and a second video, which is encoded by the second video encoder (S600).

At this time, the first video encoder may be an encoder which encodes a video based on the MPEG-2 video codec, and the second video encoder may be an encoder which encodes a video based on the MPEG-4 AVC codec. Furthermore, the first video encoder may be an encoder which encodes a video based on the MPEG-4 AVC codec, and the second video encoder may be an encoder which encodes a video based on the high efficiency video coding (HEVC) codec.

The receiving device regulates a buffer for the first T-STD stipulated in the first video encoder and a buffer for the second T-STD stipulated in the second video encoder (S610).

For example, the buffer sizes of the first T-STD and the second T-STD may be regulated. If the buffer size of the second T-STD (e.g., the cpb_size of the MPEG-4 AVC) is greater than the buffer size of the first T-STD (e.g., the VBV_size of the MPEG-2 video), the receiving device may limit the buffer size of the second T-STD to the buffer size of the first T-STD.

As another example, the buffer initial delay time of the first T-STD and the second T-STD may be regulated. If the buffer initial delay time of the second T-STD (e.g., the initial_cpb_removal_delay of the MPEG-4 AVC) is longer than the buffer initial delay time of the first T-STD (e.g., the Vbv_delay of the MPEG-2 video), the receiving device may adjust the buffer initial delay time of the second T-STD as the buffer initial delay time of the first T-STD.

The receiving device decodes the transport streams, which are received based on the buffers of the adjusted buffers of the first T-STD and the second T-STD, through the first T-STD and the second T-STD, respectively (S620).

For example, when the first video encoder encodes a video based on the MPEG-2 video codec and the second video encoder encodes a video based on the MPEG-4 AVC codec, the first T-STD may decode a transport stream which is received based on the MPEG-2 video codec, and the second T-STD may decode a transport stream which is received based on the MPEG-4 AVC codec. Furthermore, when the first video encoder encodes a video based on the MPEG-4 AVC codec and the second video encoder encodes a video based on the HEVC codec, the first T-STD may decode a transport stream which is received based on the MPEG-4 AVC codec, and the second T-STD may decode a transport stream which is received based on the HEVC codec.

In the above-described embodiments, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

The above description is only an example of the technical spirit of the present invention, and those skilled in the art may change and modify the present invention in various ways without departing from the intrinsic characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or variations induced from the meaning and scope of the appended claims and their equivalents.

What is claimed is:

1. A transport device in a video system which uses a hybrid video codec, the transport device comprising:
a first video encoder which encodes a first video using a first video codec;
a second video encoder which encodes a second video using a second video codec; and
a delay buffer for synchronizing a delay time for the first video and the second video, based on a buffer size of if a first transport stream system target decoder (T-STD) stipulated in the first video encoder and a buffer size of a second T-STD stipulated in the second video encoder.

2. The transport device of claim 1, wherein the delay buffer delays the first video which is encoded by the first video encoder, based on a difference between a buffer size of the first T-STD and a buffer size of the second T-STD.

3. The transport device of claim 1, wherein the delay buffer delays the second video which is encoded by the second video encoder, based on a difference between the buffer size of the first T-STD and the buffer size of the second T-STD.

4. The transport device of claim 1, wherein the first video codec is an MPEG-2 video codec, and the second video codec is an MPEG-4 AVC codec.

5. The transport device of claim 1, wherein the first video codec is an MPEG-4 AVC codec, and the second video codec is a high efficiency video coding (HEVC) codec.

6. The transport device of claim 1, further comprising:
a re-multiplexer which re-multiplexes the first video and the second video whose delay times have been synchronized through the delay buffer.

7. A receiving device in a video system which uses a hybrid video codec, the receiving device comprising:
a first video decoder which decodes a received transport stream using a first video codec;
a second video decoder which decodes the transport stream using a second video codec; and
a delay buffer which is connected to the first video decoder and operates,
wherein a size of the delay buffer is determined based on a difference between a buffer size of a first transport stream system target decoder (T-STD) stipulated in a first video encoder and a buffer size of a second T-STD stipulated in the second video encoder,
wherein the first T-STD is the first video decoder and the second T-STD is the second video decoder.

8. The receiving device of claim 7, wherein the delay buffer delays the transport stream, which is inputted to the first video decoder, for a predetermined delay time,
wherein the predetermined delay time is determined based on at least one of an encoding condition of the first video encoder and the second video encoder, a difference between a first decoding time stamp (DTS) and a second DTS which are drawn based on a program clock reference (PCR) within the transport stream, and a difference between a buffer initial delay time of the first T-STD and a buffer initial delay time of the second T-STD,
wherein the first DTS is information indicating a time point when the transport stream, which is inputted to the first video decoder, is to be decoded,
wherein the second DTS is information indicating a time point when the transport stream, which is inputted to the second video decoder, is to be decoded.

9. The receiving device of claim 8, wherein, when a first mode is operated for the transport stream, the transport stream is inputted to the first video decoder without a delay on the delay buffer and is decoded, and
wherein, when a second mode is operated for the transport stream, the transport stream is inputted to the delay buffer and is delayed for the predetermined time, and is then inputted to the first video decoder and is decoded.

10. The receiving device of claim 9, wherein, when the transport stream is a stream which is encoded by the first video encoder, the first mode is operated, and
wherein, when the stream is a stream which is multiplexed by the first video encoder and the second video encoder, respectively, the second mode is operated.

11. The receiving device of claim 7, wherein the first video code is an MPEG-2 video codec, and the second video code is an MPEG-4 AVC codec.

12. The receiving device of claim 7, wherein the first video codec is an MPEG-4 AVC codec, and the second video codec is a high efficiency video coding (HEVC) codec.

13. A decoder buffering method in a video system which uses a hybrid video codec, the decoder buffering method comprising:
receiving a transport stream which is generated by multiplexing a first video encoded by a first video encoder and a second video encoded by a second video;
adjusting a buffer for a first transport stream system target decoder stipulated in the first video encoder and a second T-STD stipulated in the second video encoder; and
decoding the transport stream by the first T-STD and the second T-STD based on the adjusted buffer.

14. The decoder buffering method of claim 13, wherein the adjusting of the buffer comprises:
adjusting a buffer size of the first T-STD and a buffer size of the second T-STD,
wherein, if the buffer size of the second T-STD is greater than the buffer size of the first T-STD, the buffer size of the second T-STD is limited to the buffer size of the first T-STD.

15. The decoder buffering method of claim 13, wherein the adjusting of the buffer comprises:
adjusting a buffer initial delay time of the first T-STD and a buffer initial delay time of the second T-STD,
wherein, if the buffer initial delay time of the second T-STD is longer than the buffer initial delay time of the first T-STD, the buffer initial delay time of the second T-STD is adjusted to the buffer initial delay time of the first T-STD.

16. The decoder buffering method of claim 13, wherein the first video encoder and the first T-STD use an MPEG-2 video codec, and the second video encoder and the second T-STD use an MPEG-4 AVC codec.

17. The decoder buffering method of claim 13, wherein the first video encoder and the first T-STD use an MPEG-4 AVC codec, and the second video encoder and the second T-STD use a high efficiency video coding (HEVC) codec.
